(19) United States
(12) Patent Application Publication
(10) Pub. No.: US 2026/0222098 A1
(43) Pub. Date: Jul. 30, 2026

(54) COMMUNICATION APPARATUS, COMMUNICATION SYSTEM, PROCESSING METHOD BY COMMUNICATION APPARATUS, AND A NON-TRANSITORY STORAGE MEDIUM

(71) Applicant: CANON KABUSHIKI KAISHA, Tokyo (JP)

(72) Inventor: EIJI IMAO, Kanagawa (JP)

(21) Appl. No.: 19/455,534

(22) Filed: Jan. 21, 2026

(30) Foreign Application Priority Data
Jan. 29, 2025 (JP) 2025-012753

(51) Int. Cl. H04J 3/06; H04W 56/00

(52) U.S. Cl. CPC H04J 3/0673; H04W 56/0005

(57) ABSTRACT

A communication apparatus includes a first reception unit configured to receive a first precision time protocol (PTP) packet that includes a first sequence identification (ID) and generate a first reception timestamp that indicates reception time of the first PTP packet, and a first transmission unit configured to transmit a second PTP packet that includes a second sequence ID and generate a first transmission timestamp that indicates transmission time of the second PTP packet, wherein the first transmission unit generates the second sequence ID so that the second sequence ID does not overlap a sequence ID generated by another communication apparatus that performs time synchronization.

### BACKGROUND

### Field of the Technology

The present disclosure relates to a communication apparatus, a communication system, a processing method executed by the communication apparatus, and a non-transitory storage medium.

### Description of the Related Art

Device synchronization technologies that synchronize a plurality of devices to operate as a system have been used in various fields. One example is a technique referred to as volumetric video, which uses synchronized images captured by a plurality of cameras to generate a three-dimensional video of a three-dimensional model that can be viewed from any viewpoint.

In order to synchronize imaging timing, a plurality of cameras may perform time synchronization via network communication. A technique for achieving time synchronization between network communication apparatuses, precision time protocol version 2 (PTP version 2) as specified in the Institute of Electrical and Electronics Engineers (IEEE) 1588-2008 standard has been developed.

PTP is a communication protocol used for time synchronization via communication. By performing communication between a time distribution server apparatus referred to as a grand master clock (GMC) and a client apparatus, PTP can continuously synchronize time of the client apparatus with time of the server apparatus with high precision.

Time synchronization processing using PTP requires timestamps representing time information in transmitting and receiving PTP packets. In addition, in order to achieve high precision PTP time synchronization, a hardware timestamp of a PTP packet is used. A hardware timestamp is generally generated in hardware that transmits and receives packets, such as a physical layer (PHY) and Media Access Control (MAC), which are components of a communication interface, in network communication.

A method described in Japanese Patent Application Laid-Open No. 2024-147867 describes generating and storing a hardware timestamp of a PTP packet received by a communication apparatus and making it available for time synchronization processing. According to Japanese Patent Application Laid-Open No. 2024-147867, a communication apparatus outputs a hardware timestamp of a received packet, analyzes the received packet to determine whether it is a PTP packet, further acquires an identifier of the packet from information included in the received packet, and stores it in a storage unit in association with the timestamp. Therein it is described that the identifier uses a sequence identification (ID) included in a header area of a PTP packet or a sequence number included in a Transmission Control Protocol (TCP) header area of a TCP/Internet Protocol (TCP/IP) packet.

The IEEE 1588 standard states that for PTP event messages, such as a synchronization message and a delay request message, a sequence ID assigned to the message is incremented by +1 for each transmission. However, in a case where a plurality of client apparatuses performs PTP time synchronization with a time distribution server apparatus, sequence ID values of PTP messages transmitted by the respective communication apparatuses may overlap each other.

This is because the values are not controlled to avoid overlap among the communication apparatuses but determined by each communication apparatus. Thus, in the method for storing a timestamp according to Japanese Patent Application Laid-Open No. 2024-147867, there is a possibility that identifiers of received PTP packets may overlap each other, and timestamps corresponding to the same identifier may be stored. This may result in the acquisition of an incorrect timestamp of a received PTP packet processed during time synchronization processing.

### SUMMARY

According to an aspect of the present disclosure, a communication apparatus includes a first reception unit configured to receive a first precision time protocol (PTP) packet that includes a first sequence identification (ID) and generate a first reception timestamp that indicates reception time of the first PTP packet, and a first transmission unit configured to transmit a second PTP packet that includes a second sequence ID and generate a first transmission timestamp that indicates transmission time of the second PTP packet, wherein the first transmission unit generates the second sequence ID so that the second sequence ID does not overlap a sequence ID generated by another communication apparatus that performs time synchronization.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a configuration of a communication system.

FIG. 2 illustrates an example of a hardware configuration of a communication apparatus.

FIG. 3 illustrates an example of a hardware configuration of a communication control unit.

FIG. 4 illustrates a precision time protocol (PTP) communication sequence between a time distribution server apparatus and a client apparatus.

FIG. 5 illustrates a format of a sequence identification (ID) of a PTP packet.

FIG. 6 illustrates an apparatus number assignment management table.

FIG. 7 illustrates a communication sequence for notifying a sequence ID generation rule.

FIG. 8 is a flowchart illustrating delay request message reception processing by the time distribution server apparatus

FIG. 9 is a flowchart illustrating signaling message reception processing by the client apparatus.

FIG. 10 is a flowchart illustrating signaling message reception processing by the time distribution server apparatus.

### DESCRIPTION OF THE EMBODIMENTS

### First Embodiment

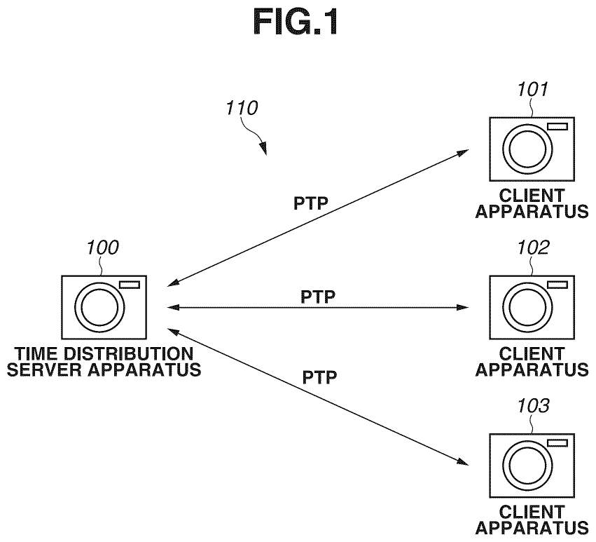

A communication apparatus having a time synchronization function is described as an example of an embodiment according to the present disclosure with reference to FIG. 1. FIG. 1 illustrates an example of a configuration of a communication system 110. The communication system 110 is a synchronous imaging system configured with a plurality of cameras.

In FIG. 1, communication apparatuses 101 to 103 have a camera function that includes image capturing and execute synchronous imaging by the four cameras. In synchronous imaging, it is necessary to synchronize system time of each communication apparatus with high precision in order to synchronize imaging timing. Among the four communication apparatuses in FIG. 1, the communication apparatus 100 operates as a time distribution server apparatus that serves as a time synchronization source. The communication apparatuses 101, 102, and 103 operate as client apparatuses that synchronize their time with the time of the time distribution server apparatus 100.

The communication system 110 includes the time distribution server apparatus 100 and the client apparatuses 101, 102, and 103.

The time distribution server apparatus 100 and the client apparatuses 101, 102, and 103 are connected to the same network and can communicate with each other. For example, they are connected by a wired local area network (LAN) confirming to the Ethernet® standard. Alternatively, the time distribution server apparatus 100 may operate as an access point of a wireless LAN, and the three client apparatuses 101, 102, and 103 may wirelessly connect to the time distribution server apparatus 100.

Further, each of the client apparatuses 101, 102, and 103 performs time synchronization with the time distribution server apparatus 100 via precision time protocol (PTP) communication. The time distribution server apparatus 100 has functions as a grand master clock (GMC) and a boundary clock (BC), which serves as a time synchronization source for PTP.

### (Hardware Configuration of Communication Apparatus)

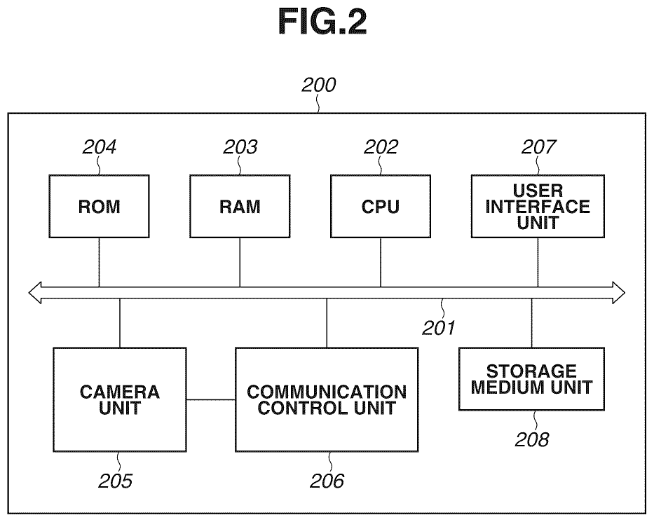

Next, a hardware configuration of the communication apparatus that has the camera function according to the present embodiment is described with reference to FIG. 2. FIG. 2 illustrates an example of a hardware configuration of a communication apparatus 200. The communication apparatus 200 corresponds to each of the time distribution server apparatus 100 and the client apparatuses 101, 102, and 103 in FIG. 1.

Inside the communication apparatus 200, a central processing unit (CPU) 202, a random access memory (RAM) 203, and a read-only memory (ROM) 204 are connected to a system bus 201. The system bus 201 is further connected to a camera unit 205, a communication control unit 206, a user interface unit 207, and a storage medium unit 208. The system bus 201 transmits data between connected blocks.

The CPU 202 executes a system program and an application program of the communication apparatus 200. The time synchronization processing according to the present embodiment is implemented as software executed by the CPU 202.

The RAM 203 is a temporary storage unit that is used in executing a system program and an application program. The RAM 203 is also used as an output buffer for captured image data and a data buffer for captured image encoding processing of and image file generation processing.

The ROM 204 is a nonvolatile storage unit that stores the above-described programs. The ROM 204 is also used as a storage destination of user setting data for the communication apparatus 200.

The camera unit 205 includes hardware units, such as a lens unit, an imaging processing unit, an image processing unit, and the like, which are necessary for imaging processing of the camera. A pulse signal having a frequency of 59.94 Hz, 50 Hz, or the like output from the communication control unit 206 is input to the camera unit 205, and an imaging timing signal having a frame rate of 59.94 fps, 50 fps, or the like is generated inside the camera unit 205. In other words, each communication apparatus 200 can perform imaging with synchronized imaging timing based on the synchronized time.

The communication control unit 206 is a network interface that connects to a network and transmits and receives transmission frames. According to the present embodiment, the communication control unit 206 includes a physical layer (PHY) and Media Access Control (MAC) of Ethernet® for a wired LAN.

The user interface unit 207 is a display and a touch sensor that can be used to operate the communication apparatus 200 and can be operated using a graphical user interface (GUI) of an application displayed on a screen.

The storage medium unit 208 is a non-volatile memory device with a large storage capacity, such as a hard disk device, a solid state drive (SSD) device, a secure digital (SD) card, a CompactFlash® card, or the like. The storage medium unit 208 is used to store still image and moving image data captured by the communication apparatus 200.

### (Hardware Configuration of Communication Control Unit 206)

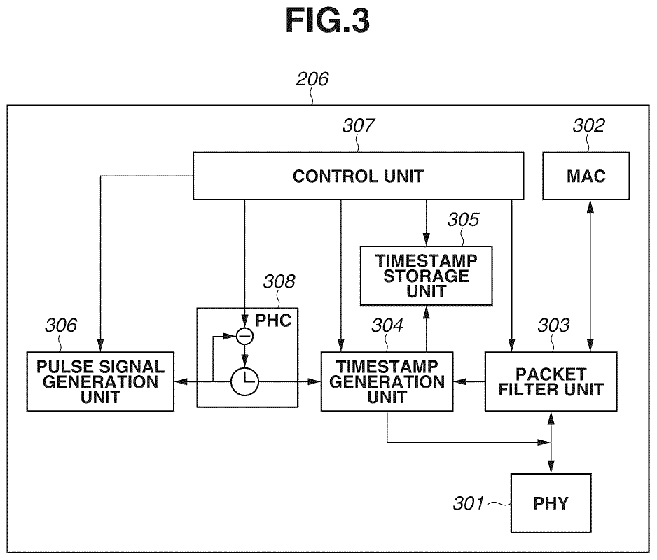

Next, a configuration of the communication control unit 206 in FIG. 2 is described with reference to FIG. 3. FIG. 3 is a block diagram illustrating an example of a hardware configuration of the communication control unit 206. The communication control unit 206 includes a PHY 301 and MAC 302 of the Ethernet®, a packet filter unit 303, a timestamp generation unit 304, a timestamp storage unit 305, a control unit 307, and a PTP hardware clock (PHC) 308.

The packet filter unit 303 in FIG. 3 determines a type of packets that the PHY 301 transmits and receives. The packet filter unit 303 analyzes packet data transmitted between the PHY 301 and the MAC 302. The packet filter unit 303 determines the type of the packet by analyzing the packet data. In a case of receiving a packet, the packet filter unit 303 also determines whether the determined packet type is a packet that cannot be received and notifies the MAC 302 of the determination. Upon receiving the notification that the packet cannot be received, the MAC 302 discards the transferred packet.

Further, the packet filter unit 303 has a function of determining whether the packet requires a timestamp by analyzing the transferred packet data in both transmission and reception and notifying the timestamp generation unit 304 of the determination. Specifically, the packet filter unit 303 determines whether the transferred packet data is a PTP packet and further determines whether it is a PTP message type that requires a timestamp. Further, in a case of a PTP packet that requires a timestamp, the packet filter unit 303 acquires information about an identifier of the PTP packet from a header area thereof. The identifier is a sequence ID. The packet filter unit 303 notifies the timestamp generation unit 304 of the information about the identifier.

The timestamp generation unit 304 in FIG. 3 detects transfer of packet data between the PHY 301 and the MAC 302 and generates a timestamp. Then, the timestamp generation unit 304 is notified by the packet filter unit 303 whether the transferred packet requires a timestamp and determines whether to store the generated timestamp. In a case where the timestamp is to be stored, the timestamp generation unit 304 outputs information about the identifier and the timestamp of the PTP packet notified by the packet filter unit 303 to the timestamp storage unit 305 and stores it therein.

The PHC 308 is a hardware clock module that measures time and continuously supplies the timestamp generation unit 304 with time in nanosecond units. In other words, the timestamp generation unit 304 generates a timestamp that is the time measured by the PHC 308. The PHC 308 also continuously supplies a pulse signal generation unit 306 with time in nanosecond units in the same manner.

The pulse signal generation unit 306 generates a pulse signal with a frequency of 59.94 Hz, 50 Hz, or the like from time information supplied from the PHC 308.

The pulse signal is output to the outside of the communication control unit 206 and input to the camera unit 205.

Finally, the control unit 307 in FIG. 3 performs setting and control on the communication control unit 206. The control unit 307 includes a hardware register that is accessed in time synchronization processing running on the CPU 202. The control unit 307 includes registers for following three representative functions.

The first function is to generate a timestamp for a PTP packet. This function performs setting and control on the packet filter unit 303 and the timestamp generation unit 304, detects a PTP packet transferred between the PHY 301 and the MAC 302, generates a timestamp, and stores the timestamp in the timestamp storage unit 305 by setting and controlling each block. This function is also capable of finely controlling timestamp acquisition, such as acquiring a timestamp only for a PTP Sync message in a received packet and a timestamp only for a PTP Delay_Resp message in a transmitted packet.

The second function is to acquire and set the time of the PHC 308. The time on the hardware clock of the PHC 308 can be adjusted by operating the register of the control unit 307. For example, if the communication apparatuses 200 are the time synchronized client apparatuses 101 to 103, this function is used in the time synchronization processing to correct the time of the PHC 308 and adjust a speed at which the clock advances.

The third function is to control a pulse signal output of the pulse signal generation unit 306. This function is also capable of controlling the start and stop of pulse signal output, the frequency setting, and the like by operating the register of the control unit 307.

### (PTP Communication Sequence)

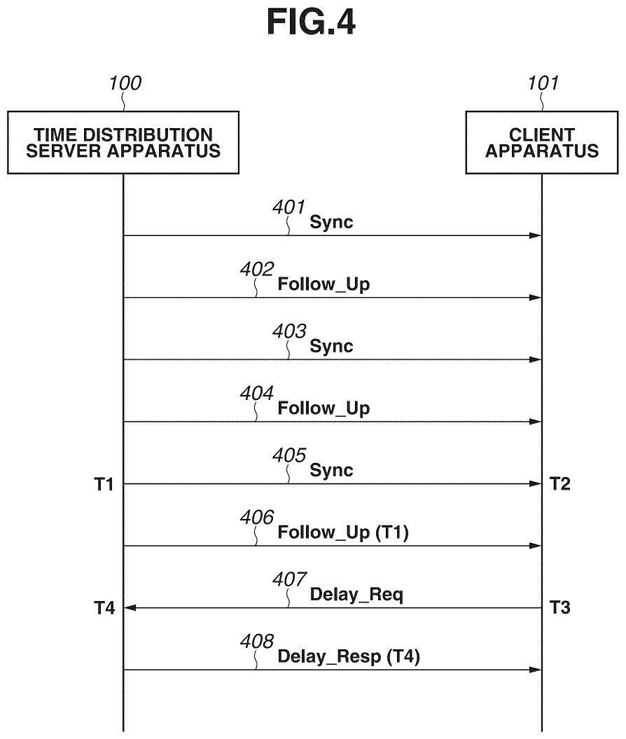

Next, a communication sequence for time synchronization is described. FIG. 4 illustrates a PTP communication sequence between the time distribution server apparatus 100 and the client apparatus 101. FIG. 4 illustrates only the minimum communication required for time synchronization of the client apparatus 101.

The time distribution server apparatus 100 continues to transmit packets of synchronization messages (Sync) at regular time intervals. Then, the client apparatus 101 receives the synchronization messages from the time distribution server apparatus 100. In FIG. 4, synchronization messages 401, 403, and 405 are illustrated.

Further, the time distribution server apparatus 100 acquires a transmission timestamp based on the time of its own PHC 308 in transmitting the synchronization message and transmits a follow-up message (Follow_Up) packet that stores the transmission timestamp. In FIG. 4, follow-up messages 402, 404, and 406 are illustrated.

The client apparatus 101 receives the follow-up message to acquire transmission time of the synchronization message. The client apparatus 101 also acquires a reception timestamp based on the time of its own PHC 308 in receiving the synchronization message.

In a case where reception of the synchronization message is stable, the client apparatus 101 transmits a delay request message (Delay_Req). In FIG. 4, a delay request message 407 is illustrated. The client apparatus 101 acquires and stores a transmission timestamp based on the time of its own PHC 308 in transmitting the delay request message.

Upon receiving the delay request message from the client apparatus 101, the time distribution server apparatus 100 acquires a reception timestamp based on the time of its own PHC 308. Then, the time distribution server apparatus 100 stores the reception timestamp in a delay response message (Delay_Resp) and transmits it. In FIG. 4, a delay response message 408 is illustrated.

Upon receiving the delay response message, the client apparatus 101 calculates a time difference between its own clock and the clock of the time distribution server apparatus 100. This calculation uses transmission time T1 and reception time T2 of the latest synchronization message at the time the delay request message is transmitted and transmission time T3 and reception time T4 of the delay request message. The time difference between the clock of the time distribution server apparatus 100 and the clock of the client apparatus 101 can be calculated using a following expression (1):

$$( ( T 2 - T 1 ) - ( T 4 - T 3 ) ) / 2 \qquad ( 1 )$$

Then, the client apparatus 101 corrects the time on its own clock based on the above-described time difference.

The PTP communication sequence between the time distribution server apparatus 100 and the client apparatus 101 for the client apparatus 101 to perform time synchronization is described above. Not only the client apparatus 101, but also the other client apparatuses 102 and 103 execute a communication sequence similar to that with the time distribution server apparatus 100.

Then, the time distribution server apparatus 100 executes communication with each of the client apparatuses 101, 102, and 103 based on the PTP communication sequence. The PTP communication is often performed via multicast communication. In multicast, packets transmitted by the other apparatuses, such as a packet of the synchronization message transmitted by the time distribution server apparatus 100, and packets transmitted by the client apparatuses 101 to 103, are received from the network.

For example, in the case of the present embodiment, the client apparatus 101 receives not only the PTP packet from the time distribution server apparatus 100, but also the PTP packets transmitted by the client apparatuses 102 and 103. The client apparatus 101 determines whether the received PTP packet is a message to be processed by itself and then performs the processing in the time synchronization processing.

The time distribution server apparatus 100 not only periodically transmits the synchronization message, but also periodically transmits a packet of an announcement message (Announce) by multicast for announcing information about its presence in the network and accuracy of its own clock, regardless of the communication sequence in FIG. 4.

### (Sequence ID of PTP Packet)

In the IEEE 1588-2008 specification, a PTP packet includes information about a common header with a fixed format for all types of PTP messages. A total size of the common header is 34 octets.

The format of the common header defines fields that carry various types of information, such as a message type (messageType), a sequence ID (sequenceId), a transmission source PTP port ID (sourcePortIdentity), and the like.

The message type field stores a specified value indicating a type of a PTP message. PTP messages are classified into two types: event messages and general messages. A synchronization message and a delay request message are event messages, while a follow-up message and a delay response message are general messages. An event message requires a timestamp to be acquired in transmission or reception, whereas a general message does not require a timestamp.

The sequence ID has a length of 16 bits and indicates an identification number of a PTP packet managed for each combination of a destination address and a PTP message type. Generally, the sequence ID of an event message is determined for each transmission source PTP port during transmission processing of a PTP packet. The IEEE 1588-2008 standard specifies that a value of the sequence ID is incremented by one for each transmission. However, the reason for incrementing by one for each transmission is not stated. Further, no specification or mechanism is defined for verifying the validity of the sequence ID on the receiving side of the PTP packet.

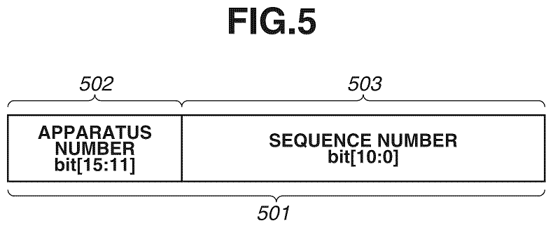

According to the present embodiment, the time distribution server apparatus 100 and the client apparatuses 101, 102, and 103 determine the sequence ID value of the event message to be transmitted and set it in the header information. The sequence ID to be determined by each communication apparatus 200 is described with reference to FIG. 5.

FIG. 5 illustrates an example of a format of a 16-bit sequence ID according to the present embodiment.

In FIG. 5, an entire sequence ID value 501 includes an apparatus number 502 and a sequence number 503. In this example, a 5-bit field is assigned as the apparatus number, and a remaining 11-bit field is assigned as the sequence number that is incremented by one at a time of transmitting a PTP event message. In a case where the incremented sequence number exceeds the 11-bit maximum value (4095), it wraps around to zero.

The number stored in the field of the apparatus number 502 is assigned a unique value of the communication apparatus 200. For example, the apparatus numbers 0, 1, 2, and 3 are respectively assigned to the time distribution server apparatus 100, the client apparatus 101, the client apparatus 102, and the client apparatus 103. In FIG. 5, since the field of the apparatus number 502 is 5 bits, up to 32 unique values can be assigned to the apparatus number 502. A field length may be changed according to the number of the communication apparatuses 200 that perform time synchronization.

### (Allocation Management of Apparatus Number)

According to the present embodiment, the time distribution server apparatus 100 manages the apparatus number 502 of the communication apparatus 200 described above. The processing for assigning the apparatus number 502 is executed in the time synchronization processing executed by the CPU 202.

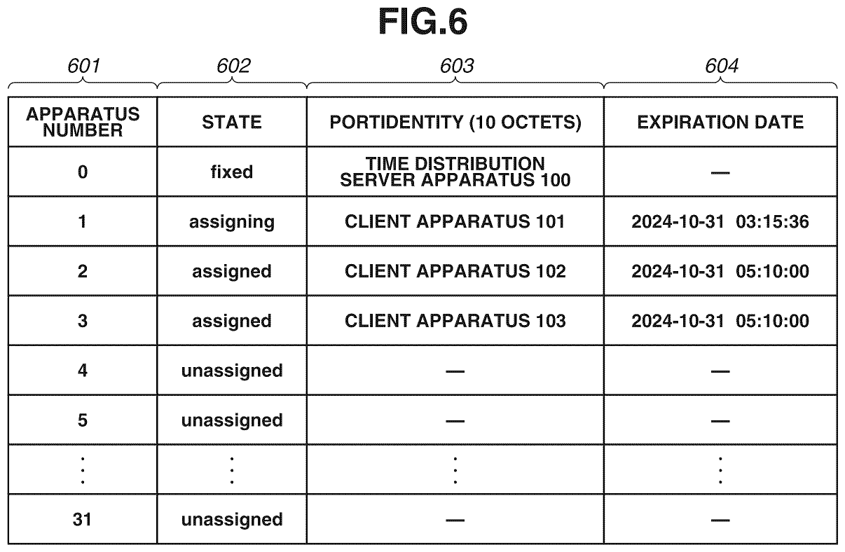

FIG. 6 illustrates an apparatus number assignment management table. In the time synchronization processing, the table is generated in the RAM 203 and used. The number of entries in the assignment management table to be generated corresponds to the number of the apparatus numbers that can be assigned in the system.

As illustrated in FIG. 6, each entry in the apparatus number assignment management table records parameters of an apparatus number 601, an apparatus number state 602, a PTP port ID (PortIdentity) 603 of the communication apparatus, and an expiration date 604.

Each parameter is described. First, the apparatus number state 602 records one of following states: unassigned, in processing being assigned (assigning), assigned, or fixedly assigned (fixed). When the apparatus number state 602 is one of “assigning”, “assigned”, or “fixed”, a PTP port ID of a target communication apparatus 200 is recorded in the PTP port ID 603.

Here, the PTP port ID is a 10-octet structure data that combines a clock ID (ClockIdentity) and a communication port number (PortNumber) used for PTP time synchronization. Further, the PTP port ID is defined in the IEEE 1588-2008 standard as an identifier for a PTP port. According to the present embodiment, the PTP port ID is treated and used as the target communication apparatus 200 to which the apparatus number is assigned.

Finally, the expiration date 604 is recorded in the “assigning” state and the “assigned” state. The expiration date of the assigning state indicates the expiration date of the apparatus number until apparatus number assigning processing is completed. On the other hand, the expiration date of the assigned state indicates the expiration date of the apparatus number assigned to the communication apparatus 200.

The time distribution server apparatus 100 manages the PTP port ID (PortIdentity) value of the communication apparatus 200 to be assigned to the apparatus number. In FIG. 6, the apparatus number 0 is fixedly assigned (fixed) to the time distribution server apparatus 100. The apparatus number 1 is being assigned (assigning) to the client apparatus 101. Further, the apparatus numbers 2 and 3 are respectively assigned to the client apparatuses 102 and 103. Then, other apparatus numbers are in an unassigned state.

In a case where the assignment of the apparatus number to the client apparatus 101 is completed, the status of the apparatus number 1 is changed to “assigned”, and the expiration date is updated. For the apparatus numbers assigned to the client apparatus 102 or 103, in a case where the PTP communication with the target communication apparatus continues, the expiration date is updated before the recorded expiration date is reached, and the assigned state is extended.

Conversely, in a case where the PTP communication does not continue until the expiration date is reached, the PTP port ID record in the entry for the assigned apparatus number is deleted, and the state of the apparatus number is changed to “unassigned”. The apparatus number becomes available for reuse. In a case where an apparatus number is newly assigned, any of the apparatus number in the unassigned state is selected, the apparatus number is updated to the assigning state, and assigning processing is executed.

### (Communication Sequence for Notifying Sequence ID Generation Rule)

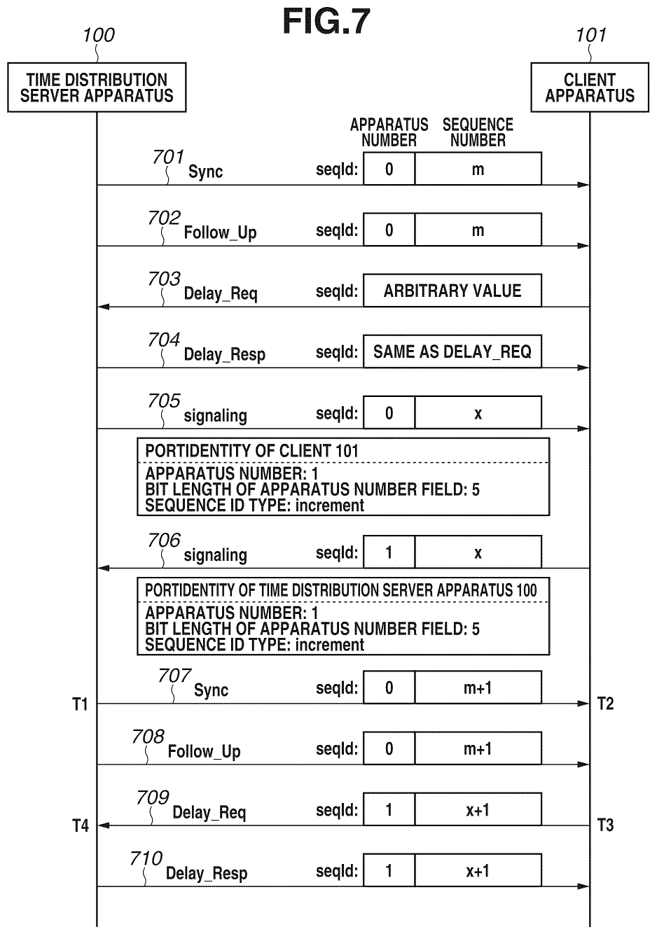

Next, a communication sequence in which the time distribution server apparatus 100 notifies the client apparatus 101 of a sequence ID generation rule is described with reference to FIG. 7. In FIG. 7, arrows represent PTP packets of PTP messages 701 to 710. Further, “seqId” attached to each of the arrows indicates the sequence ID of each of the PTP packets.

The communication sequence in FIG. 7 illustrates that the client apparatus 101 starts PTP communication by receiving a synchronization message (Sync) 701 and a follow-up message (Follow_Up) 702 from the time distribution server apparatus 100 and transmitting a first delay request message (Delay_Req) 703. At the start of the PTP communication by the client apparatus 101, the apparatus number is not yet assigned.

The synchronization message 701 indicates that the sequence ID thereof is configured with the fields of the apparatus number and the sequence number illustrated in FIG. 5. In other words, the sequence ID of the synchronization message 701 includes the apparatus number 0 and the sequence number m. The sequence ID of the follow-up message 702 is the same as that of the synchronization message 701. On the other hand, since the client apparatus 101 is not yet assigned the apparatus number, the sequence ID of the delay request message 703 may be an arbitrary value.

Upon receiving the PTP packet of the delay request message 703, the time distribution server apparatus 100 first transmits a delay response message 704. The sequence ID of the delay response message 704 is assigned the sequence ID of the received delay request message 703.

Next, the time distribution server apparatus 100 refers to the above-described apparatus number assignment management table in FIG. 6 to check whether the apparatus number is assigned to the transmission source PTP port ID (sourcePortIdentity) of the delay request message 703. Then, the time distribution server apparatus 100 determines that it is unassigned and transmits a signaling message (Signaling) 705.

The signaling message is a notification to the client apparatus 101 in which a sequence ID generation rule is described. The signaling message stores a target port ID (targetPortIdentity) for specifying a target apparatus that receives the notification. Further, the apparatus number to be assigned to the client apparatus, a field bit length of the apparatus number included in the sequence ID, and information about a sequence ID type are notified as the generation rule.

The signaling message 705 notifies the client apparatus 101 of the sequence ID generation rule in which the target port ID is the PTP port ID of the client apparatus, the apparatus number is 1, the field bit length of the apparatus number is 5, and the sequence ID type is “increment” that indicates increment by one. FIG. 7 illustrates that the sequence ID of the PTP packet of the signaling message 705 is configured with the apparatus number value 0 of the time distribution server apparatus 100 and an initial value x of the sequence number of the sequence ID generated by the client apparatus 101. However, the PTP sequence ID of the signaling message 705 may be an arbitrary value.

Upon receiving the PTP packet of the signaling message 705, the client apparatus 101 changes a sequence ID generation method in the time synchronization processing according to the sequence ID generation rule stored in the message. Then, the client apparatus 101 transmits a signaling message 706. The signaling message 706 has the same format as the signaling message 705. However, the PTP port ID of the time distribution server apparatus 100 is specified as the target port ID. The generation rule stores the same information as the signaling message 705.

Upon receiving the signaling message 706, the time distribution server apparatus 100 can determine that the sequence ID generation method is changed by the client apparatus 101 based on the notification. Accordingly, the time distribution server apparatus 100 determines that the apparatus number 1 is successfully assigned to the client apparatus 101 and updates the apparatus number assignment management table in FIG. 6.

Messages 707 to 710 in FIG. 7 represent sequences after the sequence ID generation method of the client apparatus 101 is changed. The client apparatus 101 receives a synchronization message 707 and a follow-up message 708 and transmits a delay request message 709. The sequence ID of the delay request message 709 is configured with the assigned apparatus number value 1 and the sequence number value (x+1) acquired by adding 1 to the sequence number notified by the signaling message 705.

The time distribution server apparatus 100 receives the delay request message 709 and transmits a delay response message 710 in which the same sequence ID as that of the delay request message 709 is set. The time distribution server apparatus 100 also refers to the apparatus number assignment management table described above in FIG. 6 in receiving the delay request message 709 to check whether the apparatus number is assigned. However, it is determined as “assigned”, the time distribution server apparatus 100 does not execute transmission of a signaling message.

As described above, the time distribution server apparatus 100 is the communication apparatus 200 that is a time synchronization source. The client apparatuses 101 to 103 are the communication apparatuses 200 that are time synchronization destinations.

The communication control unit 206 of the time distribution server apparatus 100 transmits the PTP packet of the signaling message 705 that includes the sequence ID. The PTP packet of the signaling message 705 includes the apparatus number (unique value) assigned to the client apparatus 101 and the sequence ID generation rule.

The communication control unit 206 of the client apparatus 101 receives the PTP packet of the signaling message 705.

The communication control unit 206 of the time distribution server apparatus 100 transmits the PTP packet of the synchronization message 707 that includes the sequence ID, and generates a transmission timestamp that indicates the transmission time T1 of the PTP packet of the synchronization message 707.

The communication control unit 206 of the client apparatus 101 receives the PTP packet of the synchronization message 707 that includes the sequence ID, and generates a reception timestamp that indicates the reception time T2 of the PTP packet of the synchronization message 707.

The communication control unit 206 of the time distribution server apparatus 100 transmits the PTP packet of the follow-up message 708 that includes the sequence ID. The PTP packet of the follow-up message 708 includes the transmission timestamp that indicates the transmission time T1.

The communication control unit 206 of the client apparatus 101 receives the PTP packet of the follow-up message 708 that includes the sequence ID.

The communication control unit 206 of the client apparatus 101 transmits the PTP packet of the delay request message 709 that includes the sequence ID, and generates a transmission timestamp that indicates the transmission time T3 of the PTP packet of the delay request message 709. At this time, the communication control unit 206 of the client apparatus 101 generates the sequence ID of the delay request message 709 based on the above-described sequence ID generation rule so as to prevent overlap with a sequence ID generated by the other communication apparatus 200 that performs time synchronization. The sequence ID of the delay request message 709 includes the apparatus number (unique value) assigned to the client apparatus 101 and the sequence number.

The communication control unit 206 of the time distribution server apparatus 100 receives the PTP packet of the delay request message 709 that includes the sequence ID, and generates a reception timestamp that indicates the reception time T4 of the PTP packet of the delay request message 709.

The communication control unit 206 of the time distribution server apparatus 100 transmits the PTP packet of the delay response message 710 that includes the sequence ID. The PTP packet of the delay response message 710 includes the reception timestamp that indicates the reception time T4.

The communication control unit 206 of the client apparatus 101 receives the PTP packet of the delay response message 710 that includes the sequence ID.

Subsequently, the communication control unit 206 of the client apparatus 101 corrects the time of the clock of the client apparatus 101 using the transmission timestamp indicating the transmission time T1, the reception timestamp indicating the reception time T2, the transmission timestamp indicating the transmission time T3, and the reception timestamp indicating the reception time T4 based on the above-described expression (1).

According to the present embodiment, the sequence ID type of the sequence ID generation rule notified by the signaling message 705 in FIG. 7 is described as “increment” indicating a method for incrementing the sequence number value by +1, but other methods may be also used. For example, the sequence number value of the sequence ID to be generated may be randomized for each transmission. In a case where a random sequence number is generated, the sequence ID type is specified as “random”.

### (Delay Request Message Reception Processing by Time Distribution Server Apparatus 100)

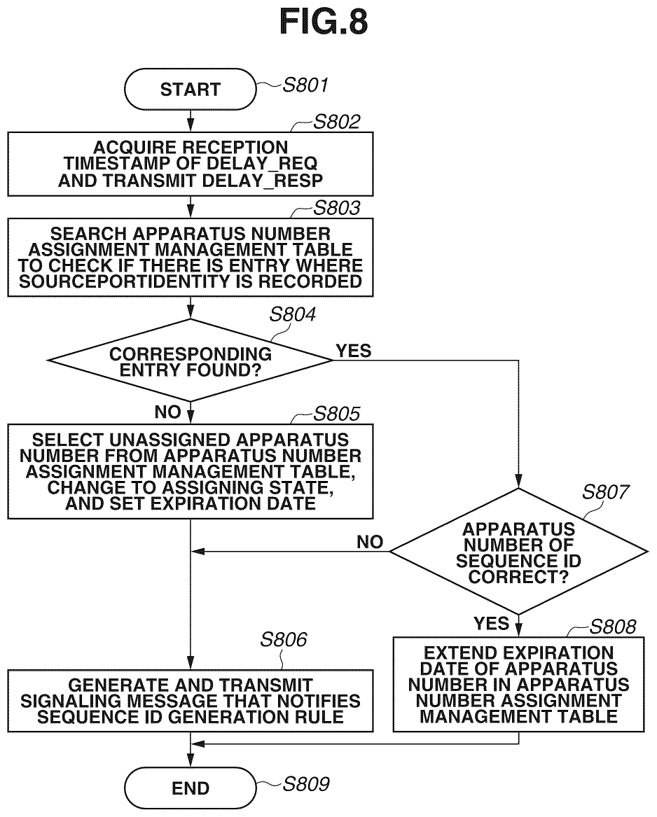

Processing performed by the time distribution server apparatus 100 to receive a delay request message is described with reference to FIG. 8. FIG. 8 is a flowchart illustrating delay request message reception processing performed by the time distribution server apparatus 100. A method for processing by the time distribution server apparatus 100 in steps S801 to S809 is described below. The processing is started from step S801.

First, in step S802, the communication control unit 206 acquires the reception timestamp of the PTP packet of the received delay request message and transmits a delay response message.

Next, in step S803, the communication control unit 206 checks whether the apparatus number is assigned to the transmission source port ID (sourcePortIdentity) included in the delay request message. The processing uses the transmission source PTP port ID as a key to search for the entry in which the apparatus number assignment management table is registered.

Then, in step S804, the communication control unit 206 determines whether the entry for the apparatus number assigned to the transmission source PTP port ID is found. In a case where the entry is found (YES in step S804), the processing proceeds to step S807. In a case where the entry is not found (NO in step S804), the processing proceeds to step S805.

In step S805, since the apparatus number is not assigned to the transmission source PTP port ID, the communication control unit 206 selects one entry to which no apparatus number is assigned from the apparatus number assignment management table. Then, the communication control unit 206 changes the state of the entry from “unassigned” to “assigning” and sets the expiration date. Next, the processing proceeds to step S806.

In step S806, the communication control unit 206 uses the selected apparatus number to generate and transmit a signaling message that notifies the selected apparatus number and the sequence ID generation rule. Then, the processing proceeds from step S806 to step S809, and the processing flow in FIG. 8 is terminated.

In step S807, in a case where the entry is found, it means that the apparatus number is already assigned or being assigned to the transmission source PTP port ID, the communication control unit 206 acquires the field value of the apparatus number 502 illustrated in FIG. 5 from the sequence ID of the received delay request message. Then, the communication control unit 206 determines whether the field value matches the apparatus number of the entry in which the PTP port ID is registered. In a case where they match (YES in step S807), the processing proceeds to step S808.

In step S808, the communication control unit 206 updates the entry in the apparatus number assignment management table so as to extend the expiration date of the apparatus number. Then, the processing proceeds from step S808 to step S809, and the processing flow in FIG. 8 is terminated.

In step S807, in a case where the field value of the apparatus number of the sequence ID in the delay request message does not match the apparatus number of the entry in which the PTP port ID is registered (NO in step S807), the processing proceeds to step S806.

In this case, in step S806, the communication control unit 206 generates and transmits a signaling message that notifies the apparatus number of the entry and the sequence ID generation rule. Then, the processing proceeds from step S806 to step S809, and the processing flow in FIG. 8 is terminated.

In FIG. 7, the time distribution server apparatus 100 receives the delay request message 703 and transmits the delay response message 704 and the signaling message 705. The above-described processing in steps S801 to S806 in the processing flow in FIG. 8 is executed, and thus the communication sequence is realized.

### (Processing for Receiving Signaling Message by Client Apparatus 101)

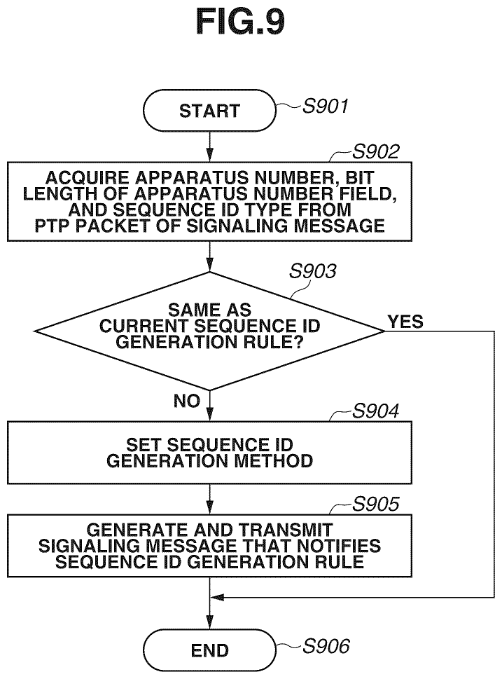

Next, processing performed by the client apparatus 101 to receive a signaling message that notifies the sequence ID generation rule is described with reference to a flowchart in FIG. 9. A method for processing by the client apparatus 101 in steps S901 to S906 is described below. The processing flow is started from step S901.

As described above, the signaling message stores the apparatus number, a bit length of the apparatus number field of the sequence ID, and the sequence ID type, so that in step S902, the communication control unit 206 acquires these parameters.

Then, in step S903, the communication control unit 206 determines whether the generation rule indicated by the acquired apparatus number, the bit length of the apparatus number field, and the sequence ID type is the same as the current sequence ID generation rule. In a case where they are the same (YES in step S903), the processing proceeds to step S906, and the processing flow in FIG. 9 is terminated. In a case where they are different (NO in step S903), the processing proceeds to step S904.

In step S904, the communication control unit 206 sets the sequence ID generation method in its own apparatus according to the notified sequence ID generation rule. Then, the processing proceeds to step S905.

In step S905, the communication control unit 206 generates and transmits a signaling message that returns the notified sequence ID generation rule as it is. Then, the processing proceeds to step S906, and the processing flow in FIG. 9 is terminated.

The sequence ID of the signaling message transmitted in step S905 is generated according to the generation rule set in step S904. In other words, the sequence ID has the format illustrated in FIG. 5 and has a value in which the notified apparatus number is stored.

### (Processing for Receiving Signaling Message by Time Distribution Server Apparatus 100)

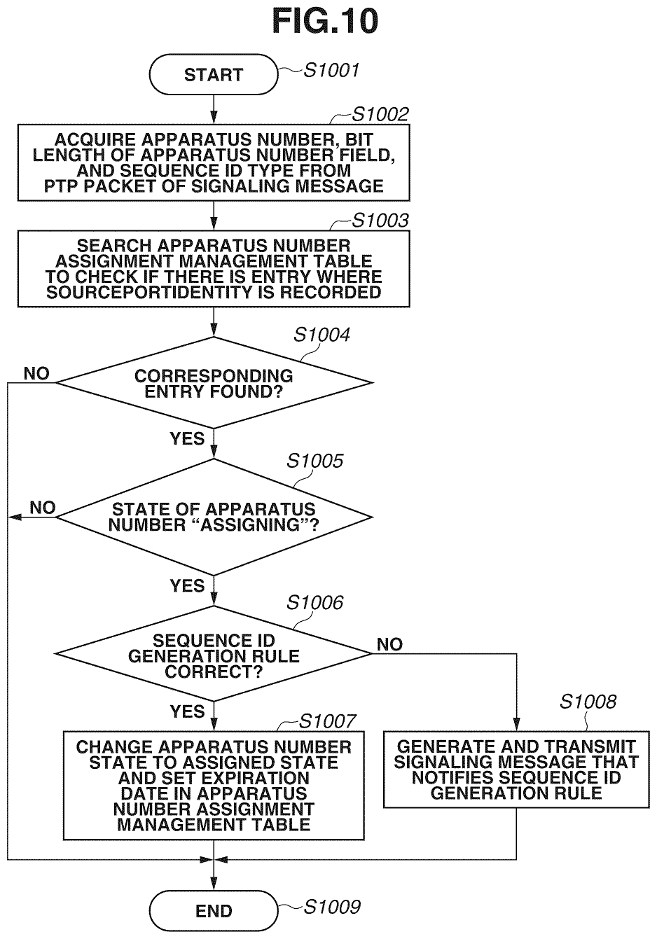

Next, processing performed by the time distribution server apparatus 100 to receive the signaling message that notifies the sequence ID generation rule transmitted from the client apparatus 101 is described with reference to a flowchart in FIG. 10. A method for processing by the time distribution server apparatus 100 in steps S1001 to S1009 is described below. The processing is started from step S1001.

In step S1002, the communication control unit 206 acquires the apparatus number, the bit length of the apparatus number field of the sequence ID, and the sequence ID type stored in the received signaling message.

In next step S1003, the communication control unit 206 uses the transmission source PTP port ID (sourcePortIdentity) of the signaling message to search the apparatus number assignment management table for the entry for the assigned apparatus number.

In next step S1004, the communication control unit 206 determines whether the entry is found. In a case where the entry is found (YES in step S1004), the processing proceeds to step S1005. In a case where the entry is not found (NO in step S1004), the processing proceeds to step S1009, and the processing in FIG. 10 is terminated.

In step S1005, the communication control unit 206 determines whether the state of the apparatus number of the entry is “assigning”. If it is “assigning” (YES in step S1005), the processing proceeds to step S1006. If it is not “assigning” (NO in step S1005), it means that the state is “assigned”, so that the processing proceeds to step S1009, and the processing flow in FIG. 10 is terminated.

In step S1006, the communication control unit 206 determines whether the sequence ID generation rule indicated by the apparatus number, the bit length of the apparatus number field of the sequence ID, and the sequence ID type is correct. This determination means checking whether the received signaling message returns the same sequence generation rule as the one notified by its own apparatus. In a case where the sequence ID generation rule is correct (YES in step S1006), the processing proceeds to step S1007. In a case where the sequence ID generation rule is not correct (NO in step S1006), the processing proceeds to step S1008.

In step S1007, the communication control unit 206 changes the apparatus number of the entry in the apparatus number assignment management table to the assigned state and sets the expiration date for the assigned state. This processing completes the assignment of the apparatus number to the client apparatus 101. Then, the processing proceeds to step S1009, and the processing flow in FIG. 10 is terminated.

In step S1008, since the sequence ID generation rule notified by the signaling message is not correct, the communication control unit 206 transmits a signaling message that stores the assigned apparatus number and the sequence ID generation rule. Then, the processing proceeds to step S1009, and the processing flow in FIG. 10 is terminated.

The communication apparatus that executes time synchronization processing is described above. According to the present embodiment, in a case where each of the client apparatuses 101, 102, and 103 performs time synchronization with the time distribution server apparatus 100 via the PTP communication, each communication apparatus 200 uses the sequence ID that includes the assigned apparatus number as part of the ID. For this reason, it is possible to avoid transmission and reception of PTP packets overlapping sequence IDs among the communication apparatuses 200. Accordingly, it is possible to prevent each communication apparatus 200 from incorrectly identifying a timestamp corresponding to an identifier included in the received PTP packet.

### Second Embodiment

According to a second embodiment, the configuration of the communication system 110 that performs time synchronization is the same as that of the first embodiment. Further, the hardware configurations of the time distribution server apparatus 100 and the client apparatuses 101 to 103 are the same as those of the first embodiment. The second embodiment is described below while indicating similarities and differences from the first embodiment.

### (Sequence ID Generation Method)

According to the second embodiment, the PTP communication sequence of the time distribution server apparatus 100 and the client apparatus 101 is the same as that illustrated in FIG. 4 according to the first embodiment.

According to the present embodiment, a random 16-bit value is generated and used as the sequence ID stored in each of the synchronization messages (Sync) 401, 403, and 405 transmitted by the time distribution server apparatus 100 in FIG. 4. Similarly, a random 16-bit value is also generated and used for the delay request message (Delay_Req) 407 transmitted by the client apparatus 101. In other words, a random value is generated within each communication apparatus for each transmission as the sequence ID for PTP event messages such as a synchronization message and a delay request message.

For example, a pseudo-random number generated in time synchronization processing operated by the CPU 202 of the communication apparatus 200 is used as the sequence ID. Generally, a pseudo-random number sequence generated by a pseudo-random number generator is uniform and unbiased, and there is no correlation in the continuity of its sequence. However, since different random number sequences are required for a plurality of communication apparatuses 200, a numerical value acquired by measuring physical noise (for example, radio noise in wireless communication) within each communication apparatus 200 is used for a seed value of the pseudo-random number.

As another implementation example, the communication apparatus 200 may be equipped with hardware such as a random number generator used in cryptographic operations and scale a random number value output by the random number generator to 16 bits to use as a sequence ID value.

As described above, the communication control unit 206 of the time distribution server apparatus 100 and the communication control unit 206 of the client apparatus 101 each generate a pseudo-random number. The sequence ID includes the pseudo-random number.

In a case where a random value is used for the sequence ID, for example, when the PTP packets of the delay request messages (Delay_Req) are consecutively received from the plurality of client apparatuses 101 to 103, there is a possibility that the sequence IDs of the PTP packets may accidentally overlap each other. However, compared to the method for determining a sequence ID by incrementing it by one as described in the IEEE 1588-2008 standard, the possibility that overlap of sequence IDs occurs is lower.

However, in a case where the sequence IDs of the PTP packets of the received PTP event messages overlap each other, the timestamp storage unit 305 of the communication control unit 206 may store a plurality of reception timestamps associated with the same identifier.

Thus, in the time synchronization processing performed by the CPU 202, the communication apparatus 200 according to the present embodiment uses an identifier extracted from the received PTP packet to acquire a timestamp stored in the timestamp storage unit 305 and checks whether a plurality of timestamps corresponds to the identifier. Then, in a case where the plurality of timestamps is stored, the communication apparatus 200 is implemented to delete these timestamps from the timestamp storage unit 305 and not use them in the PTP time synchronization processing.

As describe above, according to the first and second embodiments, in the communication system 110 in which a plurality of communication apparatuses 200 performs time synchronization using a PTP protocol, the communication apparatus 200 can identify a reception timestamp corresponding to a sequence ID included in a received PTP packet.

Since the communication apparatus 200 can prevent overlap of sequence IDs included in received PTP packets, it is possible to prevent the communication apparatus 200 from incorrectly identifying timestamps corresponding to PTP packets transmitted and received in the communication system 110 in which a plurality of communication apparatuses 200 performs time synchronization.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012753, filed Jan. 29, 2025, which is hereby incorporated by reference herein in its entirety.

What is claimed is:

1. A communication apparatus comprising:
at least one memory storing instructions; and at least one processor that, upon execution of the instructions, is configured to operate as:
a first reception unit that receives a first precision time protocol (PTP) packet that includes a first sequence identification (ID) and generates a first reception timestamp that indicates reception time of the first PTP packet; and
a first transmission unit that transmits a second PTP packet that includes a second sequence ID and generates a first transmission timestamp that indicates transmission time of the second PTP packet,
wherein the second sequence ID is generated so that the second sequence ID does not overlap a sequence ID generated by another communication apparatus that performs time synchronization.

2. The communication apparatus according to claim 1, wherein the first PTP packet and the second PTP packet are PTP packets of an event message.

3. The communication apparatus according to claim 1,
wherein the communication apparatus is a communication apparatus that serves as a time synchronization destination,
wherein the first PTP packet is a PTP packet of a synchronization message, and
wherein the second PTP packet is a PTP packet of a delay request message.

4. The communication apparatus according to claim 1,
wherein the communication apparatus is a communication apparatus that serves as a time synchronization source,
wherein the first PTP packet is a PTP packet of a delay request message, and
wherein the second PTP packet is a PTP packet of a synchronization message.

5. The communication apparatus according to claim 1, wherein execution of the stored instructions further configures the at least one processor to operate as a correction unit that uses the first reception timestamp and the first transmission timestamp and corrects time of a clock of the communication apparatus.

6. The communication apparatus according to claim 5, wherein the correction unit corrects the time of the clock of the communication apparatus using the first reception timestamp, the first transmission timestamp, a second transmission timestamp that indicates transmission time of the first PTP packet, and a second reception timestamp that indicates reception time of the second PTP packet.

7. The communication apparatus according to claim 6, Wherein execution of the stored instructions further configures the at least one processor to operate as:
a second reception unit that receive the second transmission timestamp; and
a third reception unit that receive the second reception timestamp.

8. The communication apparatus according to claim 1, wherein execution of the stored instructions further configures the at least one processor to operate as a fourth reception unit that receives a sequence ID generation rule,
wherein the second sequence ID is generated based on the sequence ID generation rule.

9. The communication apparatus according to claim 1, wherein the second sequence ID includes a unique value assigned to the communication apparatus.

10. The communication apparatus according to claim 9, wherein execution of the stored instructions further configures the at least one processor to operate as a fifth reception unit configured to receive the unique value.

11. The communication apparatus according to claim 9, wherein the second sequence ID includes the unique value and the sequence number.

12. The communication apparatus according to claim 1, wherein the second sequence ID includes a pseudo-random number.

13. The communication apparatus according to claim 12, Wherein execution of the stored instructions further configures the at least one processor to operate as a generation unit configured to generate the pseudo-random number.

14. A communication system comprising:
a first communication apparatus; and
a second communication apparatus,
wherein the first communication apparatus includes at least one memory storing instructions; and at least one processor that, upon execution of the instructions, is configured to operate as:
a first reception unit configured to receive a first PTP packet that includes a first sequence ID and generate a first reception timestamp that indicates reception time of the first PTP packet; and
a first transmission unit configured to transmit a second PTP packet that includes a second sequence ID and generate a first transmission timestamp that indicates transmission time of the second PTP packet,
wherein the first transmission unit generates the second sequence ID so that the second sequence ID does not overlap a sequence ID generated by another communication apparatus that performs time synchronization,
wherein the second communication apparatus includes:
a second transmission unit configured to transmit the first PTP packet and generate a second transmission timestamp that indicates transmission time of the first PTP packet; and
a second reception unit configured to receive the second PTP packet and generate a second reception timestamp that indicates reception time of the second PTP packet.

15. A method for processing executed by a communication apparatus, the method comprising:
receiving a first PTP packet that includes a first sequence ID and generating a first reception timestamp that indicates reception time of the first PTP packet; and
transmitting a second PTP packet that includes a second sequence ID and generating a first transmission timestamp that indicates transmission time of the second PTP packet,
wherein, the second sequence ID is generated so that the second sequence ID does not overlap a sequence ID generated by another communication apparatus that performs time synchronization.

16. A non-transitory storage medium storing a program causing a communication apparatus to execute a method for processing, the method comprising:
receiving a first PTP packet that includes a first sequence ID and generating a first reception timestamp that indicates reception time of the first PTP packet; and
transmitting a second PTP packet that includes a second sequence ID and generating a first transmission timestamp that indicates transmission time of the second PTP packet,
wherein, the second sequence ID is generated so that the second sequence ID does not overlap a sequence ID generated by another communication apparatus that performs time synchronization.
